(19) United States
(12) Patent Application Publication
(10) Pub. No.: US 2026/0361795 A1
(43) Pub. Date: Nov. 12, 2026

(54) SYSTEMS AND METHODS FOR OPERATING SYSTEM AGNOSTIC CONTACT MANAGEMENT AND SYNCHRONIZATION BETWEEN DEVICES

(71) Applicant: KEEPUPP, SRL, Waterloo (BE)

(72) Inventor: Joël RUBINFELD, Waterloo (BE)

(21) Appl. No.: 19/135,160

(22) PCT Filed: Dec. 5, 2023
(86) PCT No.: PCT/IB2023/000764

§ 371 Date: Jun. 3, 2025

Related U.S. Application Data
(60) Provisional application No. 63/430,909, filed on Dec. 7, 2022.

(51) Int. Cl. H04L 67/306; H04L 51/52; H04L 67/55

(52) U.S. Cl. CPC H04L 67/306; H04L 51/52; H04L 67/55

(57) ABSTRACT

In one embodiment, a computer-implemented method receiving, via a first application executing on a first computing device, a request to connect a first profile with a second profile associated with a second application executing on a second computing device; causing, based on the first profile and via the second application executing on the second computing device, presentation of a first application profile; and causing, based on the first profile and via a native application executing on the second computing device, presentation of a first native profile, wherein information associated with the first application profile and the first native profile is controlled based on information associated with the first profile.

### CROSS-REFERENCE TO RELATED APPLICATIONS

This application claims priority to U.S. Patent Application No. 63/430,909 filed Dec. 7, 2022, titled “Systems and Methods For Operating System Agnostic Contact Management and Synchronization Between Devices”. The application is hereby incorporated by reference in its entirety for all purposes.

### TECHNICAL FIELD

This disclosure relates to contact management. More specifically, this disclosure relates to systems and methods for operating system agnostic contact management and synchronization between devices.

### BACKGROUND

People come into contact with other people for numerous reasons. Some people meet other people in class at school, at a sporting event, at the office, at a conference, at the mall, or at any suitable event and/or location. People may desire to talk with or meet with the other people they meet in the future. For example, a businessman may desire to contact a professional he meets to hire the professional to perform a job at a later date. Oftentimes, the people may create a quick contact for a person in their smartphone, which in general contains limited information, erroneous data and, with time, outdated information. Worse yet, the people may exchange business cards, which are prone to being easily lost.

### SUMMARY

In one embodiment, a computer-implemented method may include receiving, via a first application executing on a first computing device, a request to connect a first profile with a second profile associated with a second application executing on a second computing device. The method may include causing, based on the first profile and via the second application executing on the second computing device, presentation of a first application profile. The method may also include causing, based on the first profile and via a native application executing on the second computing device, presentation of a first native profile, wherein information associated with the first application profile and the first native profile is controlled based on information associated with the first profile.

In one embodiment, a method may include receiving, at the first application executing on the first computing device, a request to remove a connection between the first profile and the second profile, deleting, from the second application executing on the second computing device, the first application profile, and deleting, from the native application operating on the second computing device, the first native profile.

In one embodiment, a method may include receiving, at the first application executing on the first computing device, a second request to update the first profile, and automatically synchronizing, based on the second request, the first profile associated with the first application profile associated with the second application executing on the second computing device, and with the first native profile associated with the native application executing on the second computing device.

In one embodiment, a method may include causing, via the second application executing on the second computing device, presentation of the first native profile in a contact list on a user interface, wherein information associated with the first native profile being presented in the contact list on the second computing device is controlled via the first application executing on the first computing device.

In one embodiment, the method may include the first profile and the second profile are associated with each other at a cloud-based computing system.

In one embodiment, causing, via the native application executing on the second computing device, presentation of the first native profile based on the first profile may include using one or more application programming interfaces associated with an operating system executing on the second computing device.

In one embodiment, a method may include the first application including at least one of a stand-alone application installed on an operating system of the first computing device, or a website executing on a browser installed on the operating system of the first computing device.

In one embodiment, a method may include the request arising from scanning a QR code, selecting a link, receiving a message, or some combination thereof.

In one embodiment, a method may include the profile being associated with a person, an animal, an entity, or some combination thereof.

In one embodiment, a method may include the first application profile and the first native profile being created at a cloud-based computing system and transmitted to the second application executing on the second computing device for presentation.

In one embodiment, a method may include the first application having a first user interface presenting the first profile, the second application comprises a second user interface presenting the first application profile, the native application comprises a native user interface presenting the native profile, or some combination thereof.

In one embodiment, a method may include the first application being presented in a different user interface than the first native application via the second application executing on the second computing device.

In one embodiment, a method may include transmitting, to the second application executing on the second computing device, one or more notifications when an update is made to the first profile.

In one embodiment, a method may include receiving, at the second application, a selection of a notification of the one or more notifications, and transferring control to a third application associated with the selected notification.

In one embodiment, a method may include the one or more notifications being associated with one or more social networks associate with the first profile.

In one embodiment, a method may include determining when a change has been made to one or more social networks associated with the first profile, and synchronizing the change with the first application profile associated with the second application and the first native profile associated with the native application.

In one embodiment, a method may include the first profile being associated with a first user of the first application, and the method may include recommending, based on one or more connections between the first profile and other profiles, one or more other users for the first user to connect with using the first application, wherein the recommending is performed via a trained machine learning model.

In one embodiment, a computer-implemented method for a user interface is disclosed. The method may include receiving, via a first user interface of a first application executing on a first computing device, a request to connect a first profile with a second profile, wherein the first profile and the second profile are associated with each other at a cloud-based computing system. The method may also include presenting, in the first user interface of the first application, the second profile, and presenting, in a second user interface of a native application executing on the first computing device, the second profile. The information associated with the second profile may be controlled via a first user interface of a first application executing on a second computing device.

In one embodiment, the method may include an update to the second profile being made at a second computing device, and the method may include presenting, in the first user interface of the first application, the update to the second profile, and presenting, in the second user interface of the native application, the update to the second profile.

In one embodiment, the method may include the information including an image, text, audio, video, or some combination thereof.

In one embodiment, the method may include the first and second profiles being associated with a person, an animal, an entity, or some combination thereof.

In one embodiment, the method may include presenting a push notification that a change was made to the second profile, receiving a selection of the push notification indicating the change was made to the second profile, and executing an application or website associated with the change.

In one embodiment, the method may include a user requesting to disconnect the first profile from the second profile, and the method may include deleting, in the first user interface of the first application, the second profile, and deleting, in the second user interface of the native application executing on the first computing device, the second profile.

In one embodiment, the method may include preventing information associated with the second profile from being modified by the first application, the native application, or both.

In one embodiment, the method may include a second computing device executing a second application associated with the second profile is prevented from modifying at least a name when a profile is created.

In one embodiment, a tangible non-transitory computer readable medium storing instructions that, when executed, cause a processing device to receive, via a first application executing on a first computing device, a request to connect a first profile with a second profile associated with a second application executing on a second computing device. The instructions, when executed, may cause the processing device to cause, based on the first profile and via the second application executing on the second computing device, presentation of a first application profile, and cause, based on the first profile and via a native application executing on the second computing device, presentation of a first native profile, wherein information associated with the first application profile and the first native profile is controlled based on information associated with the first profile.

In one embodiment, the processing device may execute instructions to receive, at the first application executing on the first computing device, a request to remove a connection between the first profile and the second profile, delete, from the second application executing on the second computing device, the first application profile, and delete, from the native application operating on the second computing device, the first native profile.

In one embodiment, the processing device may execute instructions to receive, at the first application executing on the first computing device, a second request to update the first profile, and automatically synchronize, based on the second request, the first profile associated with the first application profile associated with the second application executing on the second computing device, and with the first native profile associated with the native application executing on the second computing device.

In one embodiment, the processing device may execute instructions to cause, via the second application executing on the second computing device, presentation of the first native profile in a contact list on a user interface, wherein information associated with the first native profile being presented in the contact list on the second computing device is controlled via the first application executing on the first computing device.

In one embodiment, the first profile and the second profile are associated with each other at a cloud-based computing system.

In one embodiment, causing, via the native application executing on the second computing device, presentation of the first native profile based on the first profile further includes the processing device configured to use one or more application programming interfaces associated with an operating system executing on the second computing device.

In one embodiment, the first application may include at least one of a stand-alone application installed on an operating system of the first computing device, or a website executing on a browser installed on the operating system of the first computing device.

In one embodiment, a tangible, non-transitory computer-readable medium stores instructions that, when executed, cause a processing device to perform any operation of any method disclosed herein.

In one embodiment, a system includes a memory device storing instructions and a processing device communicatively coupled to the memory device. The processing device executes the instructions to perform any operation of any method disclosed herein.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates an example of a system architecture according to certain embodiments of this disclosure;

FIG. 2 illustrates another example of system architecture according to certain embodiments of this disclosure;

FIG. 3 illustrates an example of a method for controlling, from a first computing device, profile information on a second computing device according to certain embodiments of this disclosure;

FIG. 4 illustrates an example of a method for deleting a profile on a second computing device based on a request received at a first computing device according to certain embodiments;

FIG. 5 illustrates an example of a method for automatically synchronizing profiles on computing devices according to certain embodiments;

FIG. 6 illustrates an example of a method for a user interface of a first computing device to present information pertaining to a profile controlled by a second computing device according to certain embodiments;

FIG. 7 illustrates an example of a method for a user interface synchronization profile updates according to certain embodiments;

FIG. 8 illustrates an example of a method for deleting a profile from a computing device based on a request received at another computing device according to certain embodiments;

FIG. 9 illustrates an example of a method for performing an action based on a notification according to certain embodiments;

FIG. 10 illustrates an example of a method for receiving a request to modify a profile at a first computing device and causing the first profile to be modified at a second computing device according to certain embodiments;

FIG. 11 illustrates an example of a domain model according to certain embodiments;

FIG. 12 illustrates example data structures for friends and friend tags according to certain embodiments;

FIG. 13 illustrates an example data structure for notifications according to certain embodiments;

FIG. 14 illustrates an example sequence diagram for managing contacts according to certain embodiments;

FIG. 15 illustrates an example sequence diagram for a user selecting a push notification according to certain embodiments;

FIG. 16 illustrates example notification scenarios according to certain embodiments;

FIG. 17 illustrates example use cases for un-sharing a profile according to certain embodiments;

FIG. 18 illustrates an example use case for deleting a profile according to certain embodiments;

FIG. 19 illustrates an example computer system according to embodiments of this disclosure.

### NOTATION AND NOMENCLATURE

Various terms are used to refer to particular system components. Different entities may refer to a component by different names-this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

A “contact” may refer to a digitally stored identifier of a person, animal, entity, etc. that is associated with certain contact information (e.g., name, phone number, electronic mail address, geographical address, social network accounts, etc.). The contact may be presented in a list of an application (e.g., stand-alone or native) executing on a computing device (e.g., a contact list presented on a smartphone that includes names of people the user can contact). Contacting a user in the list may refer to calling the person's computing device, transmitting an email to the person's email address, transmitting a text message to the person's phone number, transmitting a fax to a fax number, etc.).

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

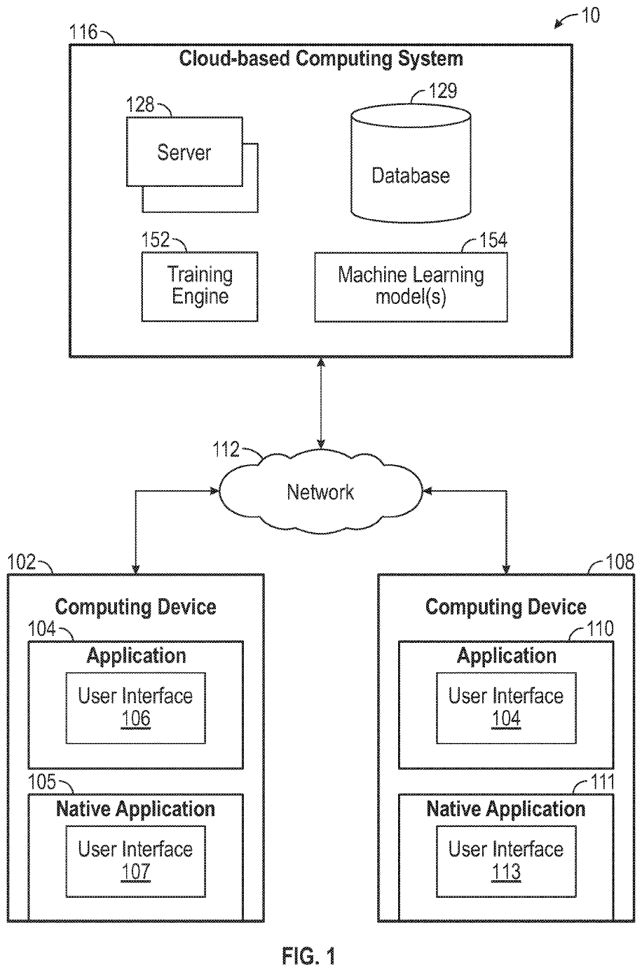

FIGS. 1 through 19, discussed below, and the various embodiments used to describe the principles of this disclosure in this patent document are by way of illustration only and should not be construed in any way to limit the scope of the disclosure.

Managing contacts is a technical problem due to incomplete information, erroneous information, or both. Hard copies of business cards does not solve the problem because business cards lack certain information and do not provide digital capabilities (e.g., launching a website or app to open a social network associated with a user). Further, business cards are oftentimes lost or thrown away. They do not provide a technical solution to maintain and track the contact for a persisted time period in a memory device and/or at a cloud-based computing system. Further, the business cards cannot be updated unless they are reprinted. In addition, a business card can't be accessed or viewed unless a person is geographical located in the same vicinity as the business card. The business card is not accessible by any computing device.

Trying to manually add and synchronize contacts is burdensome, inefficient, error-prone, and a waste of computing resources. Computing resources may be saved and reduced using the disclosed techniques that automatically synchronizes contact information in real-time or near real-time because the amount of time used to update all contacts is significantly reduced, thereby using less processing resources and memory resources.

Further, identifying who is who in a contact list is also a challenging task without any information regarding the exact place and time when the contact has been received. Contacts may be a smartphone's center of gravity, yet they are largely neglected, and often messy. The disclosed software application enables a person to build their own comprehensive and updatable profile, and share it with others.

The disclosed embodiments provide a technical solution to the technical problems presented above. The technical solution may include a digital technique for managing and synchronizing contacts among any type of device (e.g., smartphone, desktop computer, laptop computer, etc.) executing any type of operating system (e.g., Windows®, iOS®, etc.). A user's contacts of users and their profiles may be maintained in a cloud-based computing system such that the contacts may be accessed from any computing device.

Further, the disclosed embodiments may integrate various applications, such as a stand-alone application with a native contacts application executing on an operating system of a computing device. One or more application programming interfaces may be called to cause a native contact list (e.g., a graphical portion of a user interface where user's contact information (e.g., phone number, electronic mail address, name, social network accounts, etc.) is stored and presented such that a user can view the contact information and/or contact the person (e.g., call, text, email, social network media post, tec.) to add a profile of a user.

A user may share their profile with another user by using their computing device to present a quick response (QR) code, email link, text message, or the like with another user's computing device. The user's profile may be added to a contact list of a first application (e.g., KeepUpp application) and a native application. The user's profile may include the user's name, email address, phone number, geographical address, social network links, a picture, etc. The user may use the first computing device to manage their own information to ensure it is accurate, and the second user that views the second computing device may not be permitted to change any of the information in the user's profile.

When the user desires to update their own information, they may use the first computing device to change a field (e.g., birthday, social network account, etc.) and any computing device executing the first application may automatically synchronize the user's profile to present the updated field in real-time. The user's profile may be shared with multiple other user profiles (e.g., tens, hundreds, thousands, millions, etc.), and each shared instance of the user's profile may be respectively and concurrently updated in real-time or near real-time. Real-time may refer to 2 seconds or less and near real-time may refer to between 2 and 20 seconds. When the user desires to un-share or delete their user profile from a shared second user's profile, the user may transmit a delete request to the cloud-based computing system, and the user's profile may be removed from the first application and the native application executing on the second computing device.

User profiles that are shared with other user profiles, the two user profiles may be “friends” or subscribed to each other or following each other such that changes made to the user profiles are provided as notifications to the other computing devices associated with the other user profiles.

In some embodiments, the disclosed techniques may include a software application that is accessible from any environment (e.g., desktop and mobile disregarding the type of operating system). The software application may be configured to match and merge contacts' information automatically, receive automatic updates for each contact details (e.g., name, phone number, email address, social network accounts, etc.), log location and time of adding a contact for easy identification. The software application may facilitate the sharing of personal information or storing contact information and details. The software application may be implemented in computer instructions stored on one or more memory devices and executed by one or more processing devices to perform any of the methods disclosed herein.

Turning now to the figures, FIG. 1 depicts a system architecture 10 according to some embodiments. The system architecture 10 may include one or more computing devices 102 and 08 of one or more users communicatively coupled to a cloud-based computing system 116. Each of the computing devices 102 and 108 and components included in the cloud-based computing system 116 may include one or more processing devices, memory devices, and/or network interface cards. The network interface cards may enable communication via a wireless protocol for transmitting data over short distances, such as Bluetooth, ZigBee, NFC, etc. Additionally, the network interface cards may enable communicating data over long distances, and in one example, the computing devices 102 and 108 and the cloud-based computing system 116 may communicate with a network 112. Network 112 may be a public network (e.g., connected to the Internet via wired (Ethernet) or wireless (WiFi)), a private network (e.g., a local area network (LAN) or wide area network (WAN)), or a combination thereof. Network 112 may also comprise a node or nodes on the Internet of Things (IoT).

The computing devices 102 and 108 may be any suitable computing device, such as a laptop, tablet, smartphone, or computer. The computing devices 102 and 108 may include a display capable of presenting a user interface 104 and 114 of an application 106 and 114, respectively. The computing devices 102 and 108 may also store and present one or more native applications 105 and 111 that are integrated with an operating system executing on the computing devices 102 and 108. The native applications 105 and 111 may be software application that manage a contact list of contact information associated with people, animals, and/or entities. The applications 104 and 110 and the native applications 105 and 111 may be implemented in computer instructions stored on the one or more memory devices of the computing devices 102 and 108 and executable by the one or more processing devices of the computing devices 102 and 108.

The applications 104 and 110 may present various screens to a user. For example, the user interfaces 106 and 114 may present a query screen where a user can search for a person's profile (e.g., entering their phone number, name, email address, etc.), a registration screen where the user may fill out their user profile by entering their contact information (e.g., name, birthday, email address, phone number, social network accounts, etc.), a screen that presents a QR code, a screen that uses the camera device to scan another person's QR code on another computing device 108, a screen that presents a list of contacts, a screen that presents individual contact details associated with a contact, and the like.

The user interfaces 107 of the native applications 105 and 111, respectively, may present a screen with a contact list. The contact list may include contacts manually entered by the user and also contacts automatically entered by the applications 104 and 110. The contacts added by the applications 104 and 110 may be configured via one or more application programming interfaces associated with the native applications 105 and 111. The contacts that are added by the applications 104 and 110 may include a graphical element that identifies they are associated with the applications 104 and 110. The contacts not added by the applications 104 and 110 may lack the graphical element to indicate they are included in the contact list and not alterable or modifiable by the applications 104 and 110. The contacts associated with the applications 104 and 110 may be modified by a user that owns the information in their profile. Further, a contact associated with the applications 104 and 110 may cause the applications 104 and 110 to launch when selected and contact details of the selected contact may be presented.

Such techniques provide for enhanced management and synchronization of contacts. Further, the techniques provide for an enhanced user interface by providing the most desired information (e.g., based on number of previous selections) more prominently in the contact list (e.g., the contacts that are selected the most may be located toward a top of the contact list, while less selected contacts may be located toward a bottom of the contact list). Also, information that is more desirable, such as information that is selected or viewed more often than other information, may be more prominently graphically located in the user interfaces 106 and/or 114 than information less often viewed. As such, the techniques may provide for an enhanced user interface that may improve a user's experience using the computing devices 102 and 108, thereby providing a technical benefit. In some embodiments, the user interfaces 106 and 114 is executed by an application that is a stand-alone applications 104 and 110 installed and executing on the computing devices 102 and 108, respectively. In some embodiments, the application (e.g., website) executes within another application (e.g., web browser). The native applications 105 and 111 may be software programs coded specifically for a certain operating system that leverage certain operating system function calls, for example. The computing devices 102 and 108 may also include instructions stored on the one or more memory devices that, when executed by the one or more processing devices of the computing devices 102 and 108 perform operations of any of the methods described herein.

In some embodiments, the cloud-based computing system 116 may include one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine that uses one or more machine learning models 154 to perform at least one of the embodiments disclosed herein. The cloud-based computing system 116 may also include a database 129 that stores data, knowledge, and data structures used to perform various embodiments. For example, the database 129 may store user profiles as contacts, notifications, metadata, etc. In some embodiments, the database 129 may be hosted on one or more of the servers 128.

In some embodiments the cloud-based computing system 116 may include a training engine 152 capable of generating the one or more machine learning models 154. The machine learning models 154 may be trained to receive user's contact information and output recommended or suggested other contacts for the user to add (e.g., based on other users having similar contact information as the searching user). The one or more machine learning models 154 may be generated by the training engine 152 and may be implemented in computer instructions executable by one or more processing devices of the training engine 152 and/or the servers 128. To generate the one or more machine learning models 154, the training engine 152 may train the one or more machine learning models 154.

The training engine 152 may be a rackmount server, a router computer, a personal computer, a portable digital assistant, a smartphone, a laptop computer, a tablet computer, a netbook, a desktop computer, an Internet of Things (IoT) device, any other desired computing device, or any combination of the above. The training engine 152 may be cloud-based, be a real-time software platform, include privacy software or protocols, and/or include security software or protocols.

To generate the one or more machine learning models 154, the training engine 152 may train the one or more machine learning models 154. The one or more machine learning models 154 may refer to model artifacts created by the training engine 152 using training data that includes training inputs and corresponding target outputs. The training engine 152 may find patterns in the training data wherein such patterns map the training input to the target output and generate the machine learning models 154 that capture these patterns. Although depicted separately from the server 128, in some embodiments, the training engine 152 may reside on server 128. Further, in some embodiments, the database 129, and/or the training engine 152 may reside on the computing devices 102 and/or 108.

The one or more machine learning models 154 may include, e.g., a single level of linear or non-linear operations (e.g., a support vector machine [SVM]) or the machine learning models 154 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model 154 may include numerous layers and/or hidden layers that perform calculations (e.g., dot products) using various neurons.

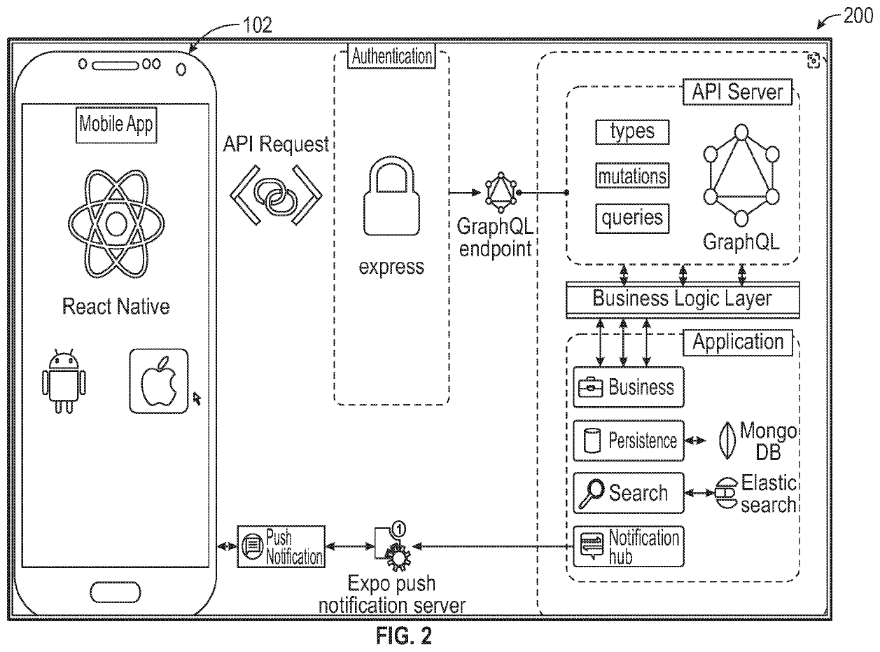

FIG. 2 illustrates another example of system architecture 200 according to certain embodiments of this disclosure. As depicted, the computing device 102 may execute a mobile application (e.g., application 106) that provides contact management and synchronization embodiments, among other embodiments, disclosed herein. One or more API requests may be made to the cloud-based computing system 116, where the servers 128 may host one or more web services. In one example, the API may expose function calls for the native applications 105 and 111 to enable creating, reading, updating, and deleting contacts in a contact list of an operating system. Further, the user and/or computing device 102 may be authenticated using a suitable authentication protocol (e.g., OAuth). The API requests, once authenticated, may be transmitted to an API server (e.g., servers 128) that interacts with a business logic layer implemented as an application executing on one or more of the servers 128. A search algorithm may be used to efficiently search thousands of contacts having a multitude of contact information. The application executing on the server may also include code that is configured as a notification hub. The notification hub may determine when to transmit notifications to user's computing devices executing the applications 104 and 110.

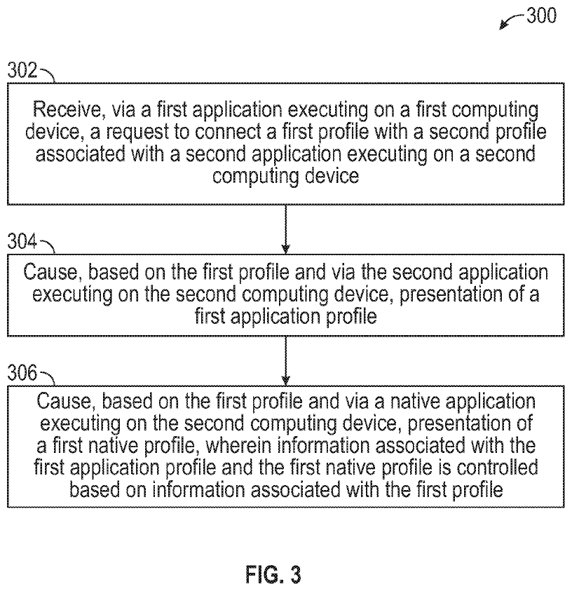

FIG. 3 illustrates an example of a method 300 for controlling, from a first computing device, profile information on a second computing device according to certain embodiments of this disclosure. The method 300 may be performed by processing logic that may include hardware (circuitry, dedicated logic, etc.), software, or a combination of both. The method 300 and/or each of their individual functions, subroutines, or operations may be performed by one or more processors of a computing device (e.g., any component (server 128, training engine 152, machine learning models 154, etc.) of cloud-based computing system 116 and/or computing devices 102 and/or 108 of FIG. 1) implementing the method 300. The method 300 may be implemented as computer instructions stored on a memory device and executable by the one or more processors. In certain implementations, the method 300 may be performed by a single processing thread. Alternatively, the method 300 may be performed by two or more processing threads, each thread implementing one or more individual functions, routines, subroutines, or operations of the methods.

For simplicity of explanation, the method 200 is depicted and described as a series of operations. However, operations in accordance with this disclosure can occur in various orders or concurrently, and with other operations not presented and described herein. For example, the operations depicted in the method 300 may occur in combination with any other operation of any other method disclosed herein. Furthermore, not all illustrated operations may be required to implement the method 300 in accordance with the disclosed subject matter. In addition, those skilled in the art will understand and appreciate that the method 300 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 302, the processing device may receive, via a first application 104 executing on a first computing device 102, a request to connect a first profile with a second profile associated with a second application 110 executing on a second computing device 108. In some embodiments, the first profile and the second profile may be associated with each other in the database 129 of the cloud-based computing system 116. In some embodiments, the first and second profiles may be associated with people, animals, entities (e.g., a company, a business, a store, a sports team, a troop, a military organization, etc.), or some combination thereof.

In some embodiments, the request may be received by scanning a QR code, selecting a link, receiving a message, sharing a username, or some combination thereof. For example, the request may be received when the user uses a camera of the first computing device 102 to scan a quick response (QR) code presented via the user interface 114 of the application 110 executing on the second computing device 108. The QR code may be associated with the second profile with which the request desires to connect to the first profile. In some embodiments, a user may search for a username of another user and a search may be performed at the cloud-based computing system 116 for the username (e.g., “@joel.rubinfeld”). If the profile associated with the username is found, the user can send a “follow” or subscribe request. The other user may receive the request and accept the request to connect the two user profiles together as “friends”. On the other hand, if the other user does not recognize the user associated with the request, the other user may decline and/or delete the request.

Further, in some embodiments, a first user of the first application 104 executing on the first computing device 102 may desire to share their profile back with the second user of the second application 110. In such an instance, the first user may select an option to share back the first user's profile with the second user's second profile. That way, both the first and second users have permission to view each other's profiles.

To that end, in some embodiments, the first user may desire to share their profile with other users without the other users sharing their profiles with the first user. For example, the first user may be trying to sell a service to customers they meet in public forums. The first user may present the user interface 106 including a QR code associated with the first profile to the customers who may use their applications 110 to scan the QR code and select a link that is presented on the user interface 114.

At block 304, the processing device may cause, based on the first profile and via the second application 110 executing on the second computing device 108, presentation of a first application profile. The first application profile may be created with the information associated with the first profile at the cloud-based computing system 116 and provided to the second application 110 executing on the computing device 108.

At block 306, the processing device may cause, based on the first profile and via a native application 111 executing on the second computing device 108, presentation of a first native profile. In some embodiments, the first native profile may be created with the information associated with the first profile at the cloud-based computing system 116 and provided to the native application 111 executing on the computing device 108. In some embodiments, information associated with the first application profile and the native profile may be controlled based on information associated with the first profile. That is, the information for the first profile may be modified on the user interface 106 of the application 104 executing on the first computing device 102. The information may be transmitted to the cloud-based computing system 116, which may modify the information associated with the first profile in the database 129. The information associated with the first application profile may be modified by the cloud-based computing system 116 and presented on user interface 114 of the application 114. Further, one or more application programming interfaces (APIs) may be called to cause the information associated with the first native profile to be updated such that it is presented in the user interface 113 of the native application 111. The APIs may be associated with an operating system executing on the second computing device 108 and may expose one or more function calls that enable interacting with the first native profile such that its values and/or properties are presented in the user interface 113.

In some embodiments, the processing device may cause, via the second application 110 executing on the native computing device 111, presentation of the first native profile in a contact list on a user interface 113. In some embodiments, information associated with the first native profile being presented in the contact list on the second computing device 108 is controlled via the first application 104 executing on the first computing device. For example, the first application 104 may receive requests to create, update, and/or delete a “friend” in the application 104. The request may be transmitted to the cloud-based computing system 116, which may make one or more API calls to the native application 111 to cause the request to be propagated to the native application's user interface 113.

In some embodiments, the first application 104 comprises a first user interface 106 presenting the first profile, the second application 110 comprises a second user interface 114 presenting the first application profile, the native application 111 comprises a native user interface 113 presenting the native profile, or some combination thereof. In some embodiments, the second application 110 may be presented in a different user interface (e.g., user interface 114) than the first native application 111 (e.g., user interface 113).

In some embodiments, the processing device may transmit, to the second application 110 executing on the second computing device 108 and/or the first application 104 executing on the first computing device 102, one or more notifications when an update is made to the first profile. In some embodiments, the processing device may receive, at the second application 108, a selection of a notification from the one or more notifications, and transfer control to a third application associated with the selected notification.

For example, the one or more notifications may be associated with one or more social networks associated with the first profile. The user may update their social network accounts by adding a new social network (e.g., Twitter®, Instagram®, Facebook®, etc.) to their user profile. The social networks may be iconized such that the graphics associated with the social networks are inserted graphically into the user profile. If someone uses an input peripheral to select the graphic icon associated with a particular social network, the user may be redirected either in the application or a web browser to the particular social network for the user's account. For example, the user may create their user profile and add their social network account username, and when the user profile is saved, the username for the social network account username may be replaced with an icon of the social network.

The update may cause a notification to be transmitted via the cloud-based computing system to any application that is currently subscribed (e.g., “friends) to the user's profile and is following the user's activity. The notification may indicate that the user has added a new social network account to their profile and provide a link to launch the application associated with the social network and/or a website associated with the social network. When the user clicks the link, control of execution may be provided by the processing device to the application and/or website, which may present the user's social network account information recently added.

In some embodiments, the processing may use one or more APIs provided by social networks to determine when any user registered with a profile using the application 104 and/or 110. Based on the determination that a change was made, the processing device may synchronize the change with the first application profile associated with the second application and the first native profile associated with the native application by making one or more API function calls.

In some embodiments the first profile may be associated with a first user of the first application 104 and the processing device may recommend, based on one or more connections between the first profile and other profiles, one or more other users for the first user to connect with using the first application 104. The recommendations may be generated and provided by one or more machine learning models. The machine learning models may be trained using training data including labeled inputs (e.g., profile information (preferences, demographic, psychographic, likes, interests, employment history, geographic location, etc.)) mapped to labeled outputs (e.g., selected profiles that other users having similar profile information have connected with).

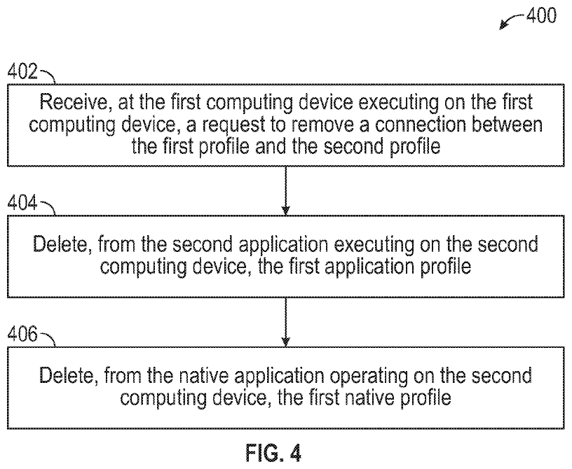

FIG. 4 illustrates an example of a method 400 for deleting a profile on a second computing device based on a request received at a first computing device according to certain embodiments. The method 400 is performed by processing logic that may include hardware (circuitry, dedicated logic, etc.), software (such as is run on a computer system or specialized dedicated machine), or a combination of both. The method 400 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 400 may be performed by a single processing thread. Alternatively, the method 400 may be performed by two or more processing threads, each thread implementing one or more individual functions, routines, subroutines, or operations of the methods. One or more operations of the method 400 may be performed by the training engine 152 and/or machine learning models 154 of FIG. 1. The method 400 may be performed in a similar manner as the method 300 of FIG. 3.

At block 402, the processing device may receive, at the first application 104 executing on the first computing device 102, a request to remove a connection between the first profile and the second profile.

At block 404, the processing device may delete, from the second application 110 executing on the second computing device 108, the first application profile.

At block 406, the processing device may delete, from the native application 111 executing on the second computing device 108, the first native profile.

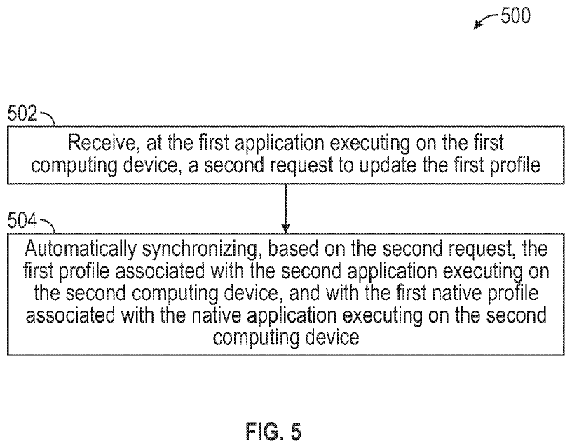

FIG. 5 illustrates an example of a method 500 for automatically synchronizing profiles on computing devices according to certain embodiments. The method 500 is performed by processing logic that may include hardware (circuitry, dedicated logic, etc.), software (such as is run on a computer system or specialized dedicated machine), or a combination of both. The method 500 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 500 may be performed by a single processing thread. Alternatively, the method 500 may be performed by two or more processing threads, each thread implementing one or more individual functions, routines, subroutines, or operations of the methods. One or more operations of the method 500 may be performed by the training engine 152 and/or machine learning models 154 of FIG. 1. The method 500 may be performed in a similar manner as the method 300 of FIG. 3.

At block 502, the processing device may receive, at the first application 104 executing on the first computing device 102, a second request to update the first profile.

At block 504, the processing device may automatically synchronize, based on the second request, the first profile with the first application profile associated with the second application 110 executing on the second computing device 108, and with the first native profile associated with the native application 111 executing on the second computing device 108.

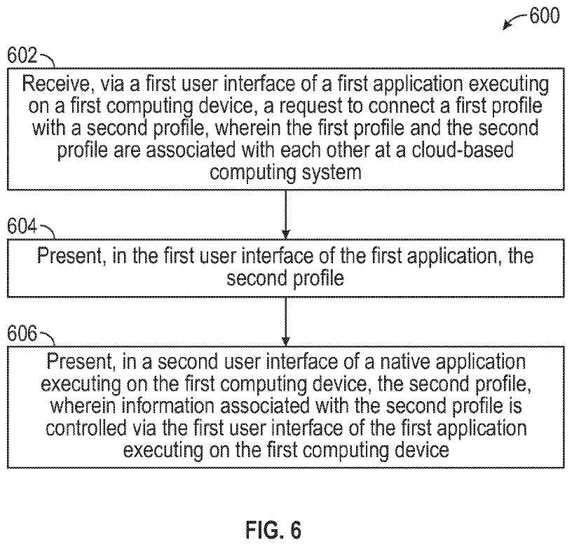

FIG. 6 illustrates an example of a method 600 for a user interface of a first computing device to present information pertaining to a profile controlled by a second computing device according to certain embodiments. The method 600 is performed by processing logic that may include hardware (circuitry, dedicated logic, etc.), software (such as is run on a computer system or specialized dedicated machine), or a combination of both. The method 600 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 500 may be performed by a single processing thread. Alternatively, the method 600 may be performed by two or more processing threads, each thread implementing one or more individual functions, routines, subroutines, or operations of the methods. One or more operations of the method 600 may be performed by the training engine 152 and/or machine learning models 154 of FIG. 1. The method 600 may be performed in a similar manner as the method 300 of FIG. 3.

At block 602, the processing device may receive, via a first user interface 106 of a first application 104 executing on a first computing device 102, a request to connect a first profile with a second profile. The first and second profiles may be associated with people, animals, entities, or some combination thereof. The first profile and the second profile may be associated with each other at the cloud-based computing system 116 as a result of the request. The request may be received as described herein. In some embodiments, the request may be received via any suitable input peripheral (e.g., mouse, keyboard, microphone, camera, etc.). The first profile may be associated with a first user of the first application 104, and the second profile may be associated with a second user of a second application110 executing on a second computing device 108.

At block 604, the processing device may present, in the first user interface 106 of the first application 104, the second profile. The second profile may include the second user's name, birthday, email address, residential address, phone number, picture, employment information, social network account links, etc.

At block 606, the processing device may present, in a second user interface 107 of a native application 105 executing on the first computing device 102, the second profile. For example, the second user interface 107 may be a native contact list provided by the native application 105 of iOS® and the second profile may be included in the native contact list with other contacts that are manually added by the first user. The information may be automatically populated and the second profile may be created such that a graphical element flags the second profile as being associated with the first application 104 executing on the computing device 102.

In some embodiments, information associated with the second profile may be controlled via a first user interface 114 of a first application 110 executing on a second computing device 108. In other words, the second profile may be controlled by the owner of the data associated with the second profile. In such a way, the disclosed embodiments provide a technical solution to a technical problem by enabling, through the use of APIs, a remote device to control private information presented on another computing device. Such control may improve privacy policies, accuracy of information, among other things.

The information may include an image, text, audio, video, or some combination thereof.

In some embodiments, the processing device may prevent information associated with the second profile from being modified by the first application 104, the native application 105, or both. That is, in some embodiments, the second profile data may be immutable on the first computing device 102. The first user may not have permissions to edit the second profile data. In some embodiments, the first user may be granted editing permissions.

Further, in some embodiments, the second computing device 108 executing the second application 110 associated with the second profile may be prevented from modifying at least a name when the second profile is created. To change the name of the second user, the second user may have to email a support and/or administration team of the second application 110. Further, two-factor authentication may be used to verify the second user is authorized to change their name in the second application 110.

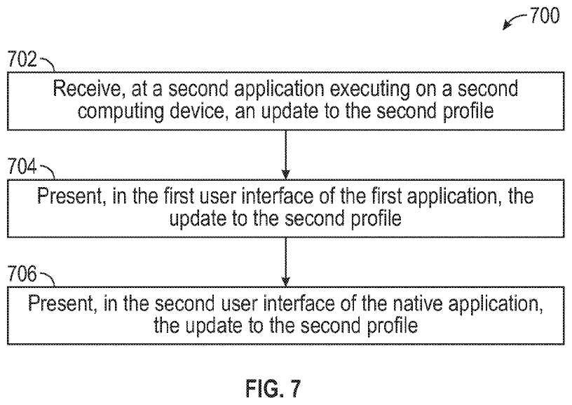

FIG. 7 illustrates an example of a method 700 for a user interface synchronization profile updates according to certain embodiments. The method 700 is performed by processing logic that may include hardware (circuitry, dedicated logic, etc.), software (such as is run on a computer system or specialized dedicated machine), or a combination of both. The method 700 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 700 may be performed by a single processing thread. Alternatively, the method 700 may be performed by two or more processing threads, each thread implementing one or more individual functions, routines, subroutines, or operations of the methods. One or more operations of the method 500 may be performed by the training engine 152 and/or machine learning models 154 of FIG. 1. The method 700 may be performed in a similar manner as the method 300 of FIG. 3.

At block 702, an update to the second profile may be made at a second computing device 108.

At block 704, the processing device may present, in the first user interface 106 of the first application 104, the update to the second profile.

At block 706, the processing device may also present, in the second user interface 107 of the native application 105, the update to the second profile.

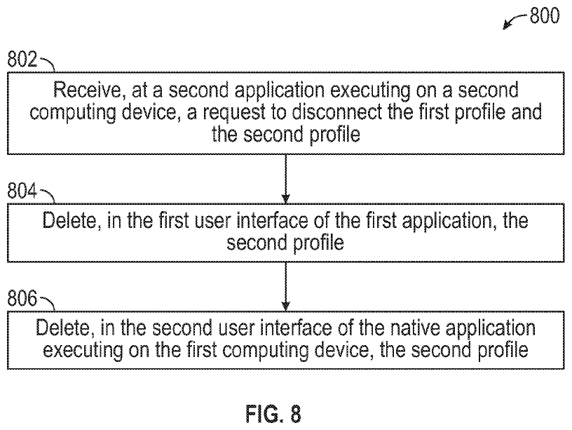

FIG. 8 illustrates an example of a method 800 for deleting a profile from a computing device based on a request received at another computing device according to certain embodiments. The method 800 is performed by processing logic that may include hardware (circuitry, dedicated logic, etc.), software (such as is run on a computer system or specialized dedicated machine), or a combination of both. The method 800 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 800 may be performed by a single processing thread. Alternatively, the method 800 may be performed by two or more processing threads, each thread implementing one or more individual functions, routines, subroutines, or operations of the methods. One or more operations of the method 800 may be performed by the training engine 152 and/or machine learning models 154 of FIG. 1. The method 800 may be performed in a similar manner as the method 300 of FIG. 3.

At block 802, the processing device may receive, at a second application 110 executing on the second computing device 108, a request to disconnect the first profile from the second profile.

At block 804, the processing device may delete, in the first user interface 106 of the first application 104 executing on the first computing device 102, the second profile.

At block 806, the processing device may delete, in the second user interface 107 of the native application 105 executing on the first computing device 102, the second profile.

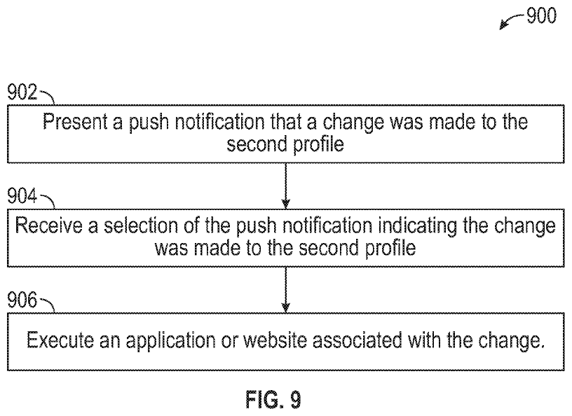

FIG. 9 illustrates an example of a method 900 for performing an action based on a notification according to certain embodiments. The method 900 is performed by processing logic that may include hardware (circuitry, dedicated logic, etc.), software (such as is run on a computer system or specialized dedicated machine), or a combination of both. The method 900 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 900 may be performed by a single processing thread. Alternatively, the method 900 may be performed by two or more processing threads, each thread implementing one or more individual functions, routines, subroutines, or operations of the methods. One or more operations of the method 900 may be performed by the training engine 152 and/or machine learning models 154 of FIG. 1. The method 900 may be performed in a similar manner as the method 300 of FIG. 3.

At block 902, the processing device may present a push notification that a change was made to the second profile.

At block 904, the processing device may receive a selection of the push notification indicating the change was made to the second profile (e.g., a social network was added to the second profile).

At block 906, the processing device may execute and application or website associated with the change (e.g., launch the social network to present information associated with the second user's social network account).

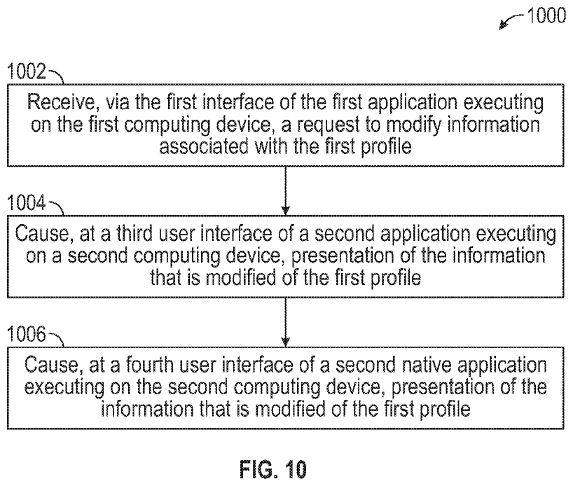

FIG. 10 illustrates an example of a method 1000 for receiving a request to modify a profile at a first computing device and causing the first profile to be modified at a second computing device according to certain embodiments. The method 1000 is performed by processing logic that may include hardware (circuitry, dedicated logic, etc.), software (such as is run on a computer system or specialized dedicated machine), or a combination of both. The method 1000 or each of their individual functions, routines, subroutines, or operations may be performed by one or more processors of a computing device (e.g., any component (server 128, training engine 152, machine learning models 154, etc.) of cloud-based computing system 116 and/or computing devices 102 and/or 108 of FIG. 1). In certain implementations, the method 1000 may be performed by a single processing thread. Alternatively, the method 1000 may be performed by two or more processing threads, each thread implementing one or more individual functions, routines, subroutines, or operations of the methods. One or more operations of the method 1000 may be performed by the training engine 152 and/or machine learning models 154 of FIG. 1. The method 1000 may be performed in a similar manner as the method 300 of FIG. 3.

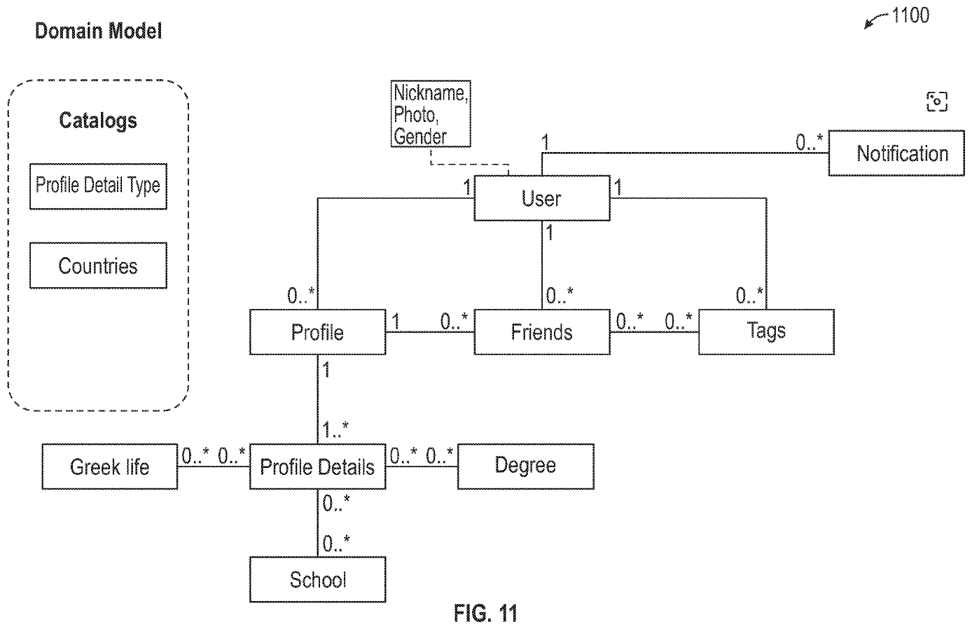

FIG. 11 illustrates an example of a domain model 1100 according to certain embodiments. The domain model 1100 may include various entities, such as Friends, User, Tags, Notification, Profile, Profile Details, School, Degree, Greek Life. The entities may be connected in various ways, for example a User may be associated with 0 or more notifications and the User may have a Nickname, Phone, and Gender. The User entity may also be associated with 0 or more Tags, 0 or more Friends, and 0 or more Profiles. In some instances, a User may create more than one profile to share with people. For example, one profile may be personal information that the User shares with their friends, and another profile may be a business profile they share with colleagues, and another profile may be a dating profile they share with people they want to date, etc. When a profile is shared with another user, when the user contacts the other user, an image that the user selected (e.g., and controls) may be displayed on a computing device of the other user. A Friend entity has 1 Profile and 0 or more Tags. The Profile entity is associated with 1 or more Profile Details, which is associated with 0 or more Greek life entities, Degrees entities, and School entities. Modeling the data in such a manner may enable performing some embodiments of the present disclosure. There are additional ways to model data that may also enable performing some embodiments of the present disclosure.

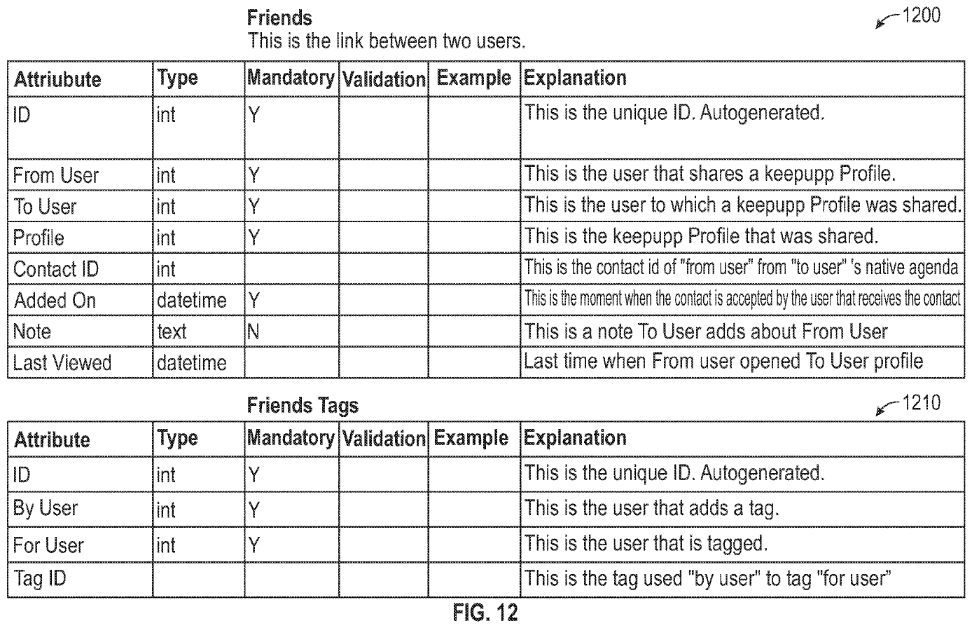

FIG. 12 illustrates example data structures for friends 1200 and friend tags 1210 according to certain embodiments. The attributes, types, mandatory status, validation, example, and explanation for each data structure are presented in tables as depicted in FIG. 12. Each value included in the table may be configured as desired. For example, a mandatory attribute may be changed to non-mandatory or optional.

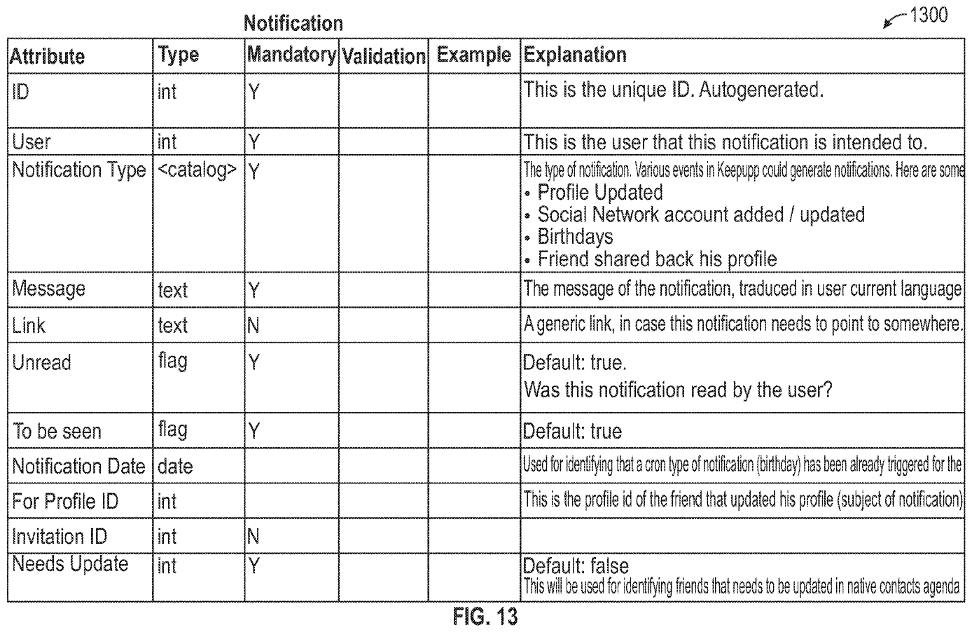

FIG. 13 illustrates an example data structure 1300 for notifications according to certain embodiments. The attributes, types, mandatory status, validation, example, and explanation for each data structure are presented in tables as depicted in FIG. 12. Each value included in the table may be configured as desired. The types of notifications may include when a profile is updated, when a social network account is added or updated, birthdays, friend shared back their profile, among others.

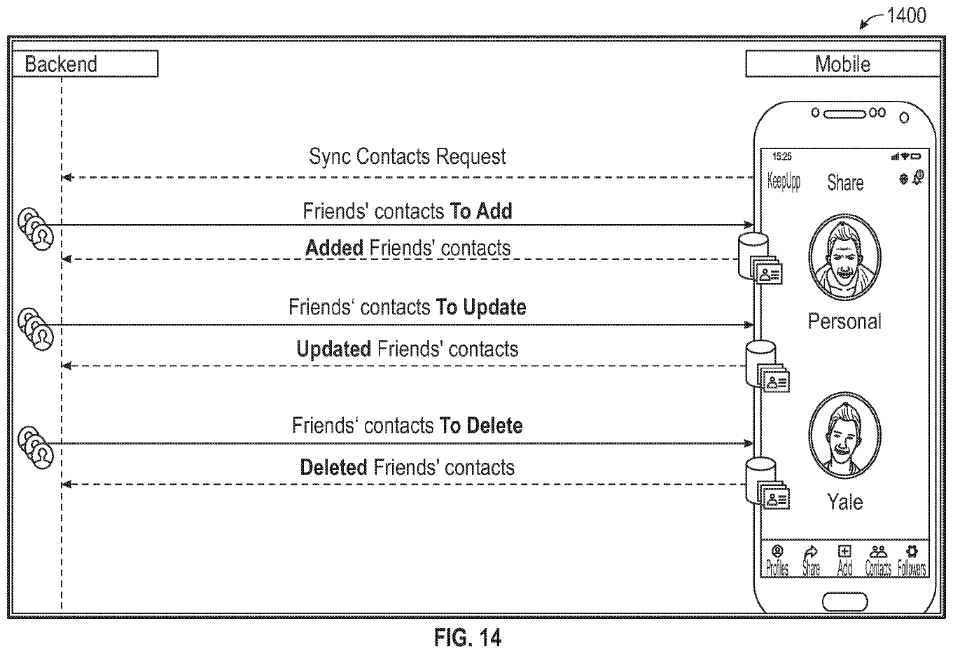

FIG. 14 illustrates an example sequence diagram 1400 for managing contacts according to certain embodiments. The two actors in the sequence diagram include a backend server 128 and a mobile computing device 102. The sequence diagram 1400 may begin with the computing device 102 requesting a synchronization of contacts to be performed. The backend server 128 may respond with Friends' contacts to add to the user's contact list, Friends' contacts to update, and/or Friends' contacts to delete. The computing device 1400 may transmit confirmation message indicating the status of the add, update, and/or delete of the Friends' contacts operations.

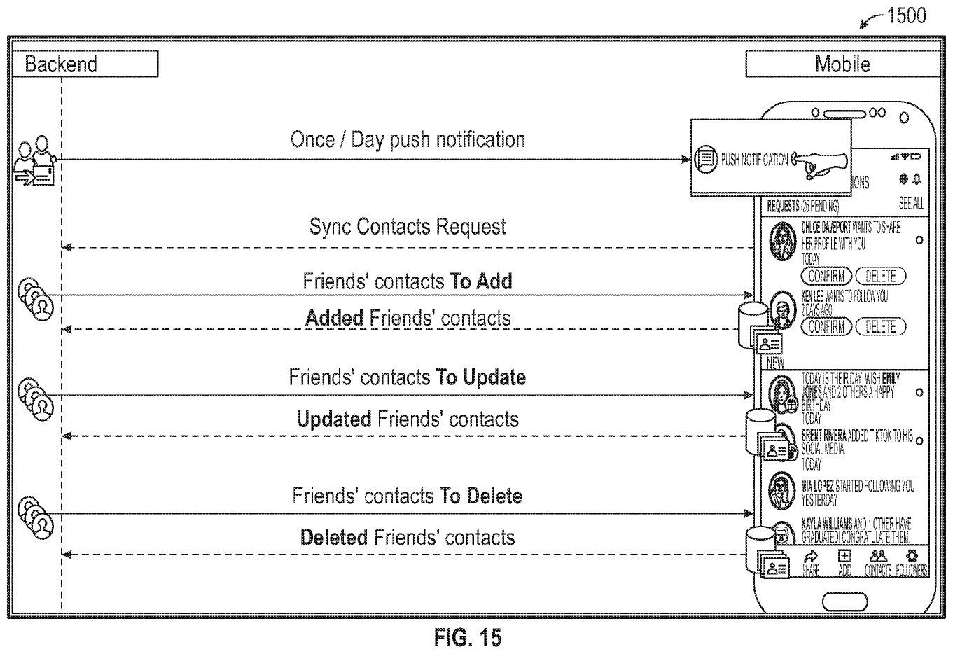

FIG. 15 illustrates an example sequence diagram 1500 for a user selecting a push notification according to certain embodiments. The two actors in the sequence diagram include a backend server 128 and a mobile computing device 102. The sequence diagram 1400 may begin with the backend server 128 transmitting a once per day push notification to the computing device 102 (the periodicity of the notification may be configurable). A user may select the push notification by touching the screen where the push notification is presented. In response, the computing device 102 may send a contacts synchronization request to the backend server and the same sequence from FIG. 14 may be performed.

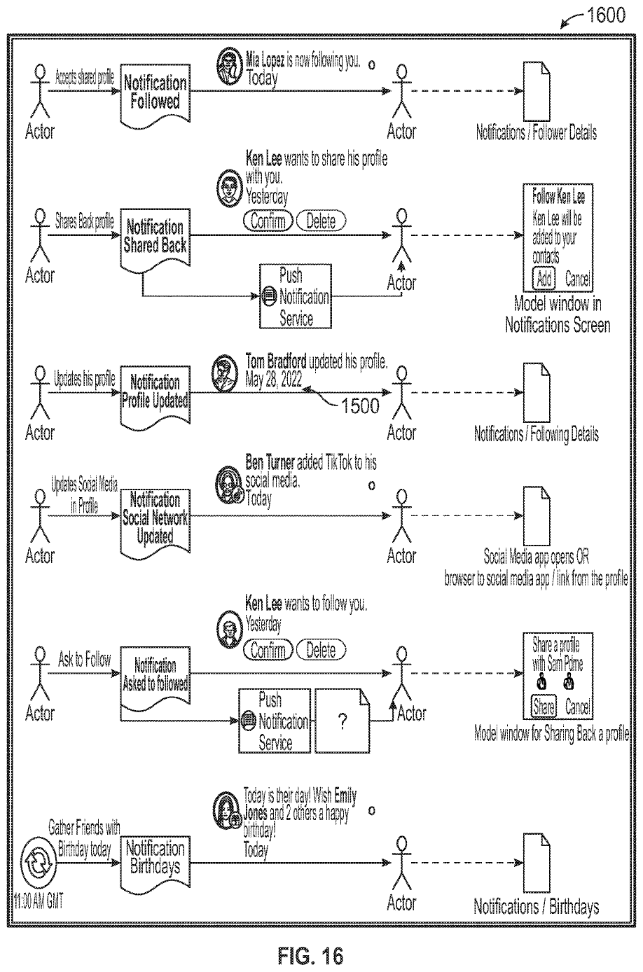

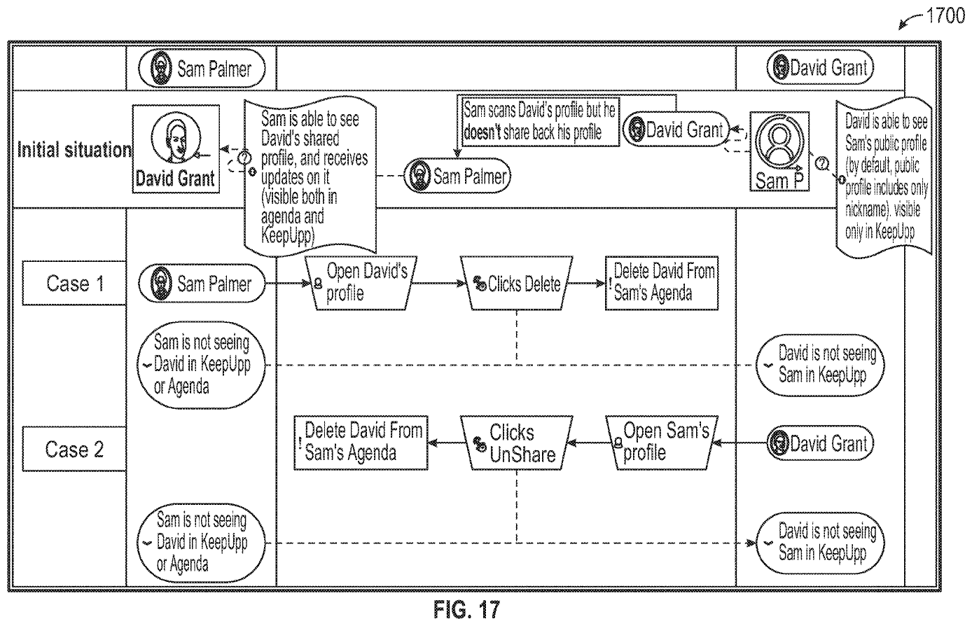

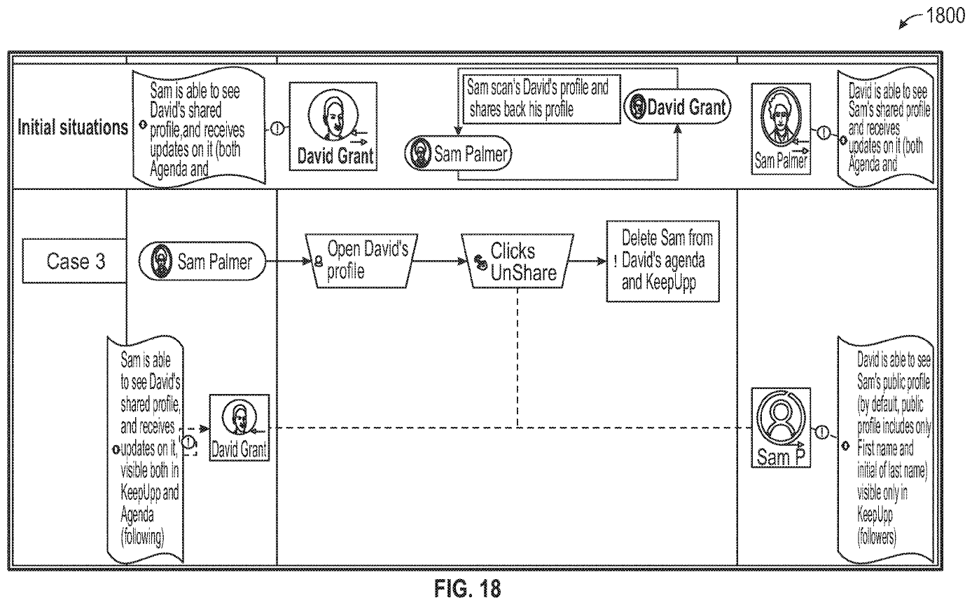

FIG. 16 illustrates example notification scenarios 1600 according to certain embodiments. As depicted, there are scenarios for followed, shared back, profile updated, social network updated, asked to follow, and birthday. FIG. 17 illustrates example use cases 1700 for un-sharing a profile according to certain embodiments. FIG. 18 illustrates an example use case 1800 for deleting a profile according to certain embodiments.

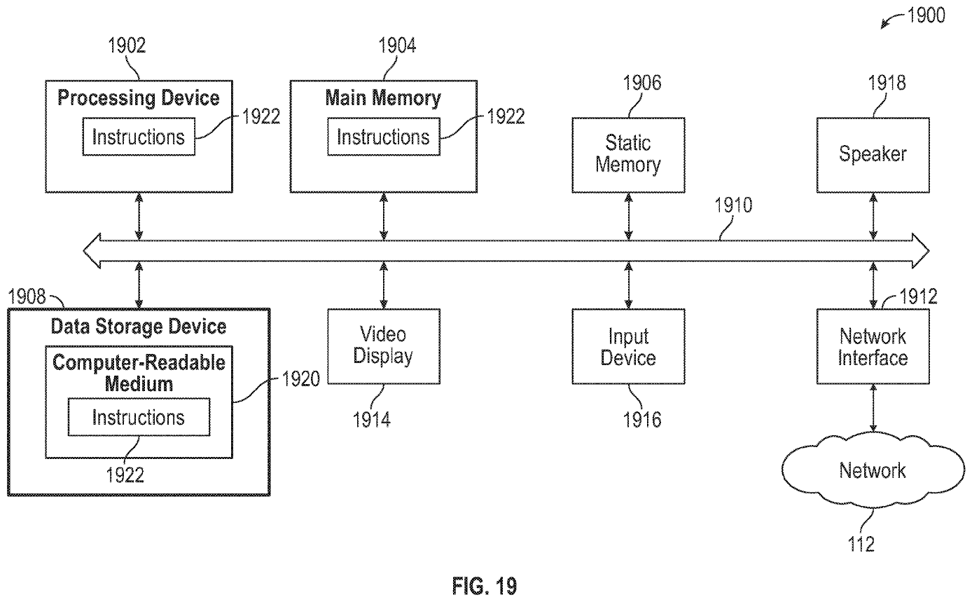

FIG. 19 illustrates an example computer system 1900, which can perform any one or more of the methods described herein. In one example, computer system 1900 may include one or more components that correspond to the computing devices 102 and/or 108, one or more servers 128 of the cloud-based computing system 116, or one or more training engines 152 of the cloud-based computing system 116 of FIG. 1. The computer system 1900 may be connected (e.g., networked) to other computer systems in a LAN, an intranet, an extranet, or the Internet. The computer system 1900 may operate in the capacity of a server in a client-server network environment. The computer system 1900 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1900 includes a processing device 1902, a main memory 1904 (e.g., read-only memory (ROM), solid state drive (SSD), flash memory, dynamic random access memory (DRAM) such as synchronous DRAM (SDRAM)), a static memory 1906 (e.g., solid state drive (SSD), flash memory, static random access memory (SRAM)), and a data storage device 1908, which communicate with each other via a bus 1910.

Processing device 1902 represents one or more general-purpose processing devices such as a microprocessor, central processing unit, or the like. More particularly, the processing device 1902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1902 may also be one or more special-purpose processing devices such as an application specific integrated circuit (ASIC), a field programmable gate array (FPGA), a digital signal processor (DSP), network processor, or the like. The processing device 1902 is configured to execute instructions for performing any of the operations and steps of any of the methods discussed herein.

The computer system 1900 may further include a network interface device 1912. The computer system 1900 also may include a video display 1914 (e.g., a liquid crystal display (LCD) or a cathode ray tube (CRT)), one or more input devices 1916 (e.g., a keyboard and/or a mouse), and one or more speakers 1918 (e.g., a speaker). In one illustrative example, the video display 1914 and the input device(s) 1916 may be combined into a single component or device (e.g., an LCD touch screen).

The data storage device 1916 may include a computer-readable medium 1920 on which the instructions 1922 embodying any one or more of the methodologies or functions described herein are stored. The instructions 1922 may also reside, completely or at least partially, within the main memory 1904 and/or within the processing device 1902 during execution thereof by the computer system 1900. As such, the main memory 1904 and the processing device 1902 also constitute computer-readable media. The instructions 1922 may further be transmitted or received over a network 20 via the network interface device 1912.

While the computer-readable storage medium 1920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A computer-implemented method comprising:
receiving, via a first application executing on a first computing device, a request to connect a first profile with a second profile associated with a second application executing on a second computing device;
causing, based on the first profile and via the second application executing on the second computing device, presentation of a first application profile; and
causing, based on the first profile and via a native application executing on the second computing device, presentation of a first native profile, wherein information associated with the first application profile and the first native profile is controlled based on information associated with the first profile.

2. The computer-implemented method of claim 1, further comprising:
receiving, at the first application executing on the first computing device, a request to remove a connection between the first profile and the second profile;
deleting, from the second application executing on the second computing device, the first application profile; and
deleting, from the native application operating on the second computing device, the first native profile.

3. The computer-implemented method of claim 1, further comprising:
receiving, at the first application executing on the first computing device, a second request to update the first profile; and
automatically synchronizing, based on the second request, the first profile with the first application profile associated with the second application executing on the second computing device, and with the first native profile associated with the native application executing on the second computing device.

4. The computer-implemented method of claim 1, further comprising:
causing, via the native application executing on the second computing device, presentation of the first native profile in a contact list on a user interface, wherein information associated with the first native profile being presented in the contact list on the second computing device is controlled via the first application executing on the first computing device.

5. The computer-implemented method of claim 1, wherein the first profile and the second profile are associated with each other at a cloud-based computing system.

6. The computer-implemented method of claim 1, wherein causing, via the native application executing on the second computing device, presentation of the first native profile based on the first profile further comprises using one or more application programming interfaces associated with an operating system executing on the second computing device.

7. The computer-implemented method of claim 1, wherein the first application comprises at least one of a stand-alone application installed on an operating system of the first computing device, or a website executing on a browser installed on the operating system of the first computing device.

8. The computer-implemented method of claim 1, wherein the request comprises scanning a QR code, selecting a link, receiving a message, or some combination thereof.

9. The computer-implemented method of claim 1, wherein the first and second profile are associated with a person, an animal, an entity, or some combination thereof.

10. The computer-implemented method of claim 1, wherein the first application profile and the first native profile are created at a cloud-based computing system and transmitted to the second application executing on the second computing device for presentation.

11. The computer-implemented method of claim 1, wherein the first application comprises a first user interface presenting the first profile, the second application comprises a second user interface presenting the first application profile, the native application comprises a native user interface presenting the first native profile, or some combination thereof.

12. The computer-implemented method of claim 1, wherein the second application is presented in a different user interface than the first native application.

13. The computer-implemented method of claim 1, further comprising transmitting, to the second application executing on the second computing device, one or more notifications when an update is made to the first profile.

14. The computer-implemented method of claim 13, further comprising:
receiving, at the second application, a selection of a notification of the one or more notifications; and
transferring control to a third application associated with the selected notification.

15. The computer-implemented method of claim 13, wherein the one or more notifications are associated with one or more social networks associate with the first profile.

16. The computer-implemented method of claim 1, further comprising:
determining when a change has been made to one or more social networks associated with the first profile; and
synchronizing the change with the first application profile associated with the second application and the first native profile associated with the native application.

17. The computer-implemented method of claim 1, wherein the first profile is associated with a first user of the first application, and the method further comprises:
recommending, based on one or more connections between the first profile and other profiles, one or more other users for the first user to connect with using the first application, wherein the recommending is performed via a trained machine learning model.

18. A computer-implemented method for a user interface, wherein the method comprises:
receiving, via a first user interface of a first application executing on a first computing device, a request to connect a first profile with a second profile, wherein the first profile and the second profile are associated with each other at a cloud-based computing system;
presenting, in the first user interface of the first application, the second profile; and
presenting, in a second user interface of a native application executing on the first computing device, the second profile, wherein:
information associated with the second profile is controlled via a first user interface of a first application executing on a second computing device.

19. The computer-implemented method of claim 18, wherein an update to the second profile is made at a second computing device, and the method further comprising:
presenting, in the first user interface of the first application, the update to the second profile; and
presenting, in the second user interface of the native application, the update to the second profile.

20. The computer-implemented method of claim 18, wherein the information comprises an image, text, audio, video, or some combination thereof.

21. The computer-implemented method of claim 18, wherein the first and second profiles are associated with a person, an animal, an entity, or some combination thereof.

22. The computer-implemented method of claim 18, further comprising:
presenting a push notification that a change was made to the second profile;
receiving a selection of the push notification indicating the change was made to the second profile; and
executing an application or website associated with the change.

23. The computing-implemented method of claim 18, wherein a user requests to disconnect the first profile from the second profile, and the method further comprises:
deleting, in the first user interface of the first application, the second profile; and
deleting, in the second user interface of the native application executing on the first computing device, the second profile.

24. The computer-implemented method of claim 18, further comprising preventing information associated with the second profile from being modified by the first application, the native application, or both.

25. The computer-implemented method of claim 18, wherein a second computing device executing a second application associated with the second profile is prevented from modifying at least a name when a profile is created.

26. A tangible non-transitory computer-readable medium storing instructions that, when executed, cause a processing device to:
receive, via a first application executing on a first computing device, a request to connect a first profile with a second profile associated with a second application executing on a second computing device;
cause, based on the first profile and via the second application executing on the second computing device, presentation of a first application profile; and
cause, based on the first profile and via a native application executing on the second computing device, presentation of a first native profile, wherein information associated with the first application profile and the first native profile is controlled based on information associated with the first profile.

27. The computer-readable medium of claim 26, wherein the processing device is further configured to:
receive, at the first application executing on the first computing device, a request to remove a connection between the first profile and the second profile;
delete, from the second application executing on the second computing device, the first application profile; and
delete, from the native application operating on the second computing device, the first native profile.

28. The computer-readable medium of claim 26, wherein the processing device is further configured to:
receive, at the first application executing on the first computing device, a second request to update the first profile; and
automatically synchronize, based on the second request, the first profile with the first application profile associated with the second application executing on the second computing device, and with the first native profile associated with the native application executing on the second computing device.

29. The computer-readable medium of claim 26, wherein the processing device is further configured to:
cause, via the native application executing on the second computing device, presentation of the first native profile in a contact list on a user interface, wherein information associated with the first native profile being presented in the contact list on the second computing device is controlled via the first application executing on the first computing device.

30. The computer-readable medium of claim 26, wherein the first profile and the second profile are associated with each other at a cloud-based computing system.

31. The computer-readable medium of claim 26, wherein causing, via the native application executing on the second computing device, presentation of the first native profile based on the first profile further comprises using one or more application programming interfaces associated with an operating system executing on the second computing device.

32. The computer-readable medium of claim 26, wherein the first application comprises at least one of a stand-alone application installed on an operating system of the first computing device, or a website executing on a browser installed on the operating system of the first computing device.
